(19) United States
(12) Patent Application Publication
(10) Pub. No.: US 2010/0006120 A1
(43) Pub. Date: Jan. 14, 2010

(54) Dental floss holder

(76) Inventors: Chung-Shan Shen, Yunlin Hsien (TW); Chun-Chiung Shen, Yunlin Hsien (TW)

Correspondence Address: CHARLES E. BAXLEY, ESQUIRE, 90 JOHN STREET, SUITE 309, NEW YORK, NY, 10038, US

(21) Appl. No.: 12/217,879

(22) Filed: Jul. 9, 2008

(51) Int. Cl. A61C 15/04

(52) U.S. Cl. 132/325

(57) ABSTRACT

A dental floss holder has a main body and a stretching assembly. The stretching assembly is mounted on the main body and has a mounting member, a one-way rotating bolt, a nut, a spring and a fixing bolt. The mounting member has a base, multiple first pawl teeth and a stud formed on the base. The one-way rotating bolt is mounted rotatably on the stud and has a threaded section having a teeth end and a spring end, an enlarged head formed on the teeth end and having multiple second pawl teeth engaging the first pawl teeth on the base and a through hole accommodating the stud. The nut is screwed on the one-way rotating bolt. The spring is mounted around the stud and engages the spring end of the threaded section. The fixing bolt is mounted on the stud and extends through and holds the spring.

### BACKGROUND OF THE INVENTION

1. Field of Invention

The present invention relates to a dental floss holder, and more particularly to a dental floss holder that can stretch or release a dental floss easily and lower the length of the dental floss holder.

2. Description of the Related Art

A dental floss holder is used to fasten and stretch a dental floss in place. A conventional dental floss holder as disclosed in inventor's US Patent Application with publication No. 2005/0247328 and shown in FIG. 8 includes a main body (60), a retractable member (70), a rotation screw and a control member (80). The main body (60) is hollow and has a first end and a second end. The retractable member (70) is mounted movably on the first end of the main body (60). The rotation screw is mounted rotatably in the main body (60) and has an upper end and a lower end. The upper end of the rotation screw engages the retractable member (70) in a threaded manner to move the retractable member (70) axially relative to the main body (60) by the rotation of the rotation screw. The control member (80) is mounted rotatably on the second end of the main body (60) and engages the lower end of the rotation screw to rotate the rotation screw.

Though the conventional dental floss holder can stretch a dental floss with the rotation of the rotation screw to extend the retractable member (70), the dental floss holder is long because the additional control member (80) is needed to rotate the rotation screw. This limits the capability of mounting other components onto the conventional dental floss holder.

To overcome the shortcomings, the present invention provides a dental floss holder to mitigate or obviate the aforementioned problems.

### SUMMARY OF THE INVENTION

The primary objective of the present invention is to provide a dental floss holder that can stretch or release a dental floss easily and lower the length of the dental floss holder.

A dental floss holder in accordance with the present invention comprises a main body and a stretching assembly. The stretching assembly is mounted securely on the main body and comprises a mounting member, a one-way rotating bolt, a nut, a spring and a fixing bolt. The mounting member comprises a base, multiple first pawl teeth formed on the base and a stud formed on the base. The one-way rotating bolt is mounted rotatably on the stud and has a threaded section, an enlarged head and a through hole. The threaded section has a teeth end and a spring end. The enlarged head is mounted on the teeth end of the threaded section and has a bottom surface facing the base and multiple second pawl teeth formed on the bottom surface of the enlarged head and corresponding to and engaging the first pawl teeth on the base. The through hole is defined through the one-way rotating bolt and accommodates the stud. The nut is screwed on the one-way rotating bolt. The spring is mounted around the stud and engages the spring end of the threaded section of the one-way rotating bolt. The fixing bolt is mounted on the stud and extends through and holds the spring.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a dental floss holder in accordance with the present invention;

FIG. 2 is an exploded perspective view of a stretching member of the dental floss holder in FIG. 1;

FIG. 3 is an enlarged side view in partial section of the stretching member of the dental floss holder in FIG. 1;

FIG. 4 is a side view in partial section of the dental floss holder in FIG. 1 with a floss package;

FIG. 5 is a perspective view of the dental floss holder in FIG. 1;

FIG. 6 is an operational perspective view of the dental floss holder in FIG. 1 with a dental floss;

FIG. 7 is an operational side view in partial section of the dental floss holder in FIG. 4 with a pulsating; and

FIG. 8 is an operational perspective view of a dental floss holder in accordance with the prior art.

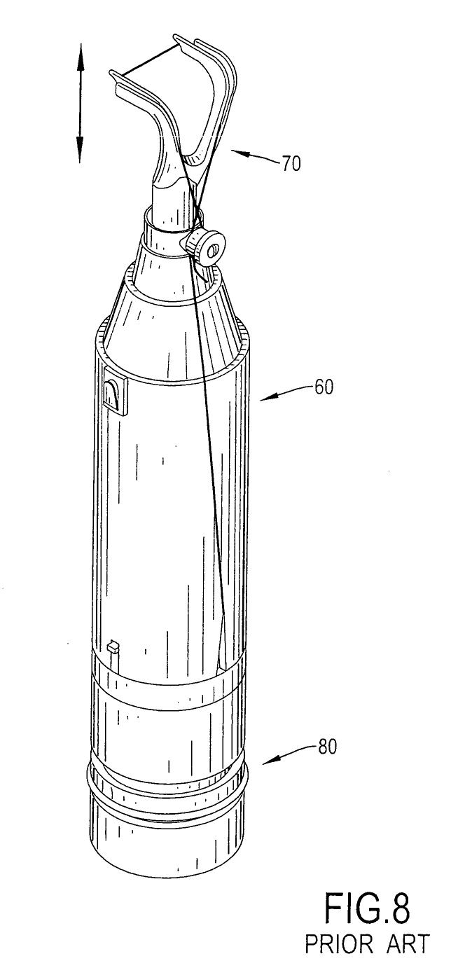

### DETAILED DESCRIPTION OF THE INVENTION

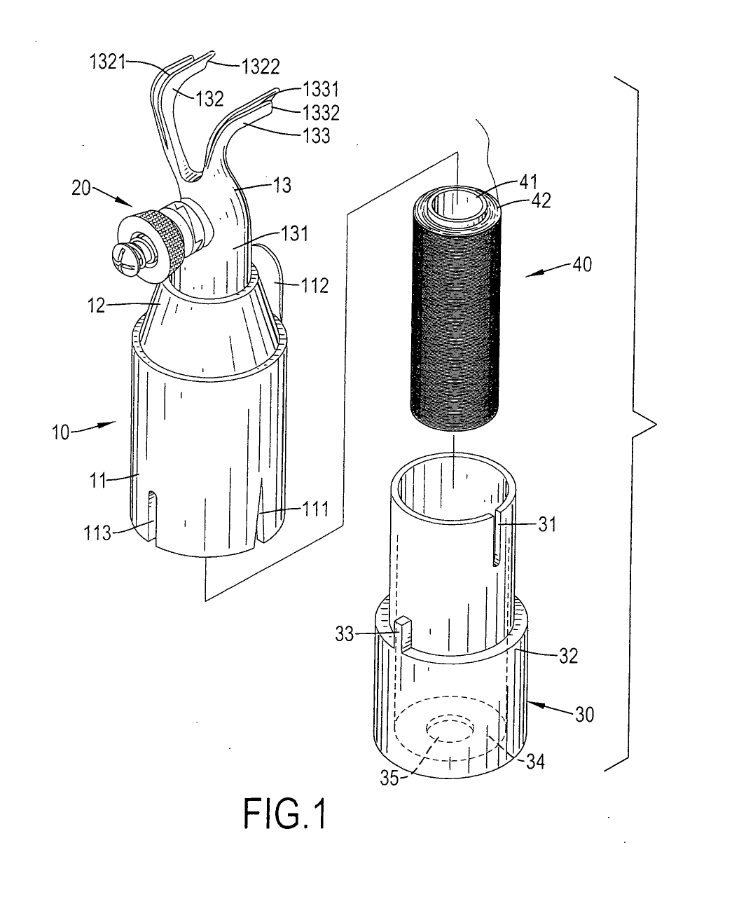

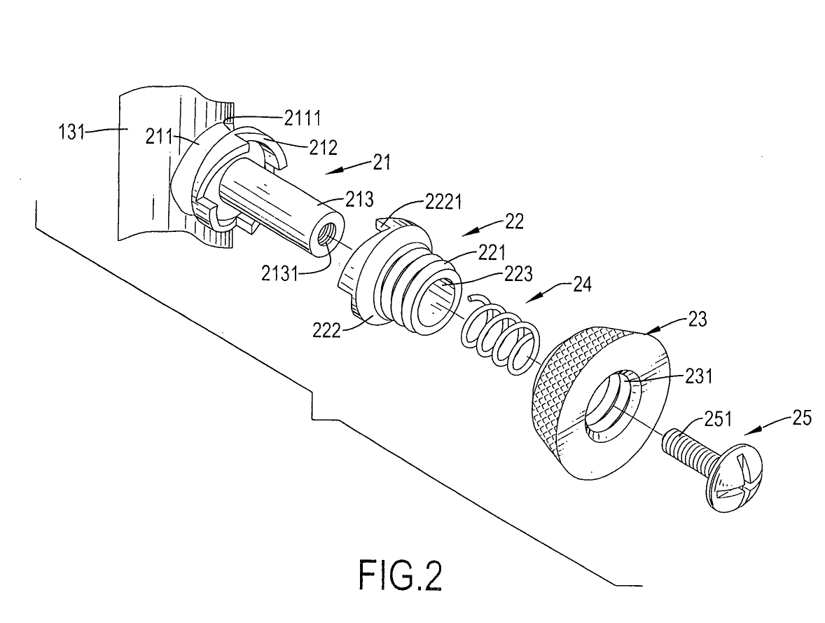

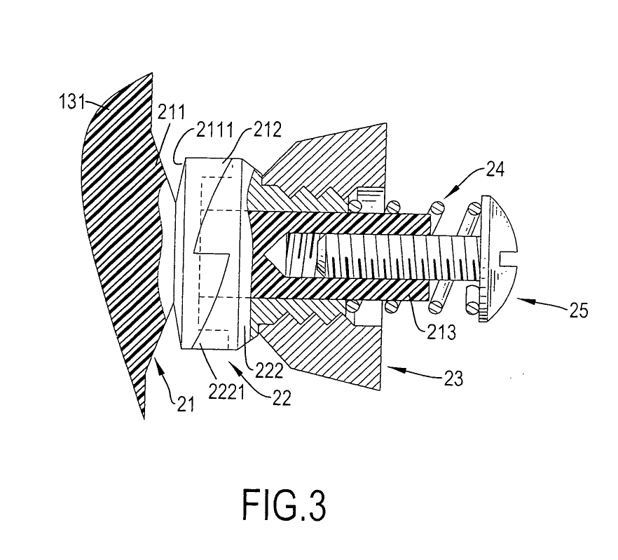

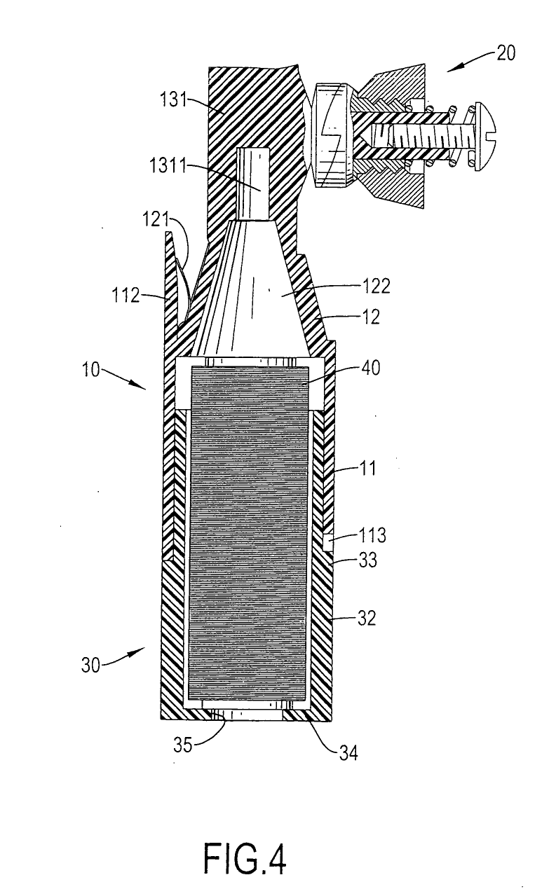

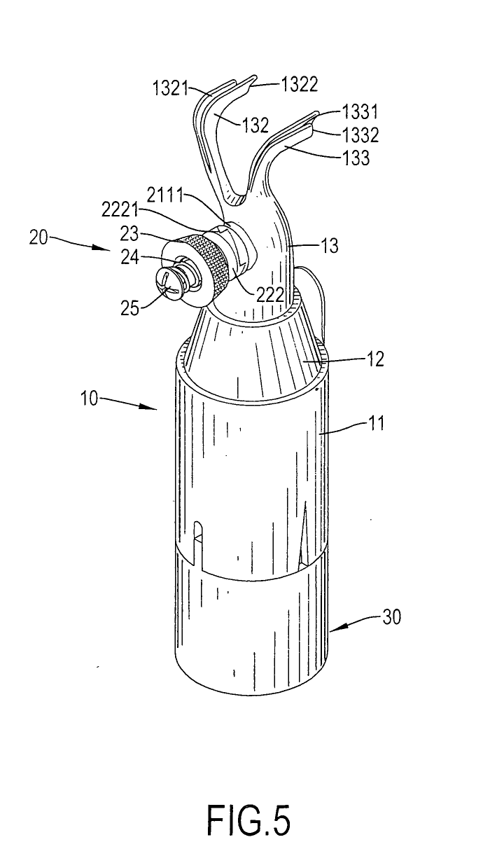

With reference to FIGS. 1 to 5, a dental floss holder in accordance with the present invention comprises a main body (10), a stretching assembly (20), a holding member (30), a floss package (40) and a pulsating assembly (50).

The main body (10) may comprise a housing (11), a tapered section (12) and a supporting member (13). The housing (11) is tubular and has an inserting end, a mounting end, a receiving chamber, a notch (111), a separator (112) and at least one positioning slot (113). The receiving chamber is defined through the housing (11). The notch (111) is triangular and is defined in the inserting end of the housing (11) to allow a dental floss to extend through the housing (11). The separator (112) is formed on and protrudes upward from the mounting end of the housing (11). The at least one positioning slot (113) is defined in the mounting end of the housing (11).

The tapered section (12) is mounted on the mounting end of the housing (11) and has an outer surface, a cutter (121) and a tapered chamber (122). The cutter (121) is mounted on the outer surface of the tapered section (12) and faces the separator (112) on the housing (11) so as to prevent the cutter (121) from hurting a user. The tapered chamber (122) is defined through the tapered section (12) and communicates with the receiving chamber in the housing (11).

The supporting member (13) is mounted on the tapered section (12) and comprises a connector (131), a first supporting bar (132) and a second supporting bar (133). The connector (131) is connected to the tapered section (12) and has a distal end and a mounting hole (1311). The mounting hole (1311) is defined in the connector (131) and communicates with the tapered chamber (122) in the tapered section (12). The first supporting bar (132) is substantially inverted L-shaped, is mounted on the distal end of the connector (131) and has an upper surface, a distal end, a positioning groove (1321) and a positioning recess (1322). The positioning groove (1321) is defined in the upper surface of the first supporting bar (132) to position the dental floss. The positioning recess (1322) is defined in the distal end of the first supporting bar (132) to position the dental floss. The second supporting bar (133) is substantially inverted L-shaped, is mounted on the distal end of the connector (131) and has an upper surface, a distal end, a positioning groove (1331) and a positioning recess (1332). The positioning groove (1331) is defined in the upper surface of the second supporting bar (133) to position the dental floss. The positioning recess (1332) is defined in the distal end of the second supporting bar (133) to position the dental floss.

The stretching assembly (20) is mounted securely on the main body (10), extends opposite to the supporting bars (132) and comprises a mounting member (21), a one-way rotating bolt (22), a nut (23), a spring (24) and a fixing bolt (25). The mounting member (21) comprises a base (211), multiple first pawl teeth (212) and a stud (213). The base (211) is circular, is mounted on the connector (131) of the supporting member (13) and has an annular surface, an outer surface and an annular groove (2111). The annular groove (2111) is defined in the annular surface of the base (211) to position the dental floss. The first pawl teeth (212) are formed on the outer surface of the base (211). The stud (213) is cylindrical, is formed on the center of the outer surface of the base (211) and has a distal end and an inner thread (2131). The inner thread (2131) is formed in the distal end of the stud (213).

The one-way rotating bolt (22) is mounted rotatably on the stud (213) on the base (211) and has a threaded section (221), an enlarged head (222) and a through hole (223). The threaded section (221) has a teeth end, a spring end, an outer surface and an outer thread. The outer thread is formed on the outer surface of the thread section (221). The enlarged head (222) is formed on the teeth end of the threaded section (221) and has an outer surface facing the base (211) and multiple second pawl teeth (2221). The second pawl teeth (2221) are formed on the outer surface of the enlarged head (222) and correspond to and engage the first pawl teeth (212) on the base (211) to keep the one-way rotating bolt (22) from rotating reversely. The through hole (223) is defined through the one-way rotating bolt (22) and accommodates the stud (213) on the base (211).

The nut (23) is screwed on the one-way rotating bolt (22) to rotate the one-way rotating bolt (22) and has an outer surface and an inner thread (231). The outer surface is rough to facilitate the user rotating the nut (23). The inner thread (231) corresponds to and engages the outer thread on the one-way rotating bolt (22).

The spring (24) is mounted around the distal end of the stud (213) and abuts the spring end of threaded section (221) of the one-way rotating bolt (22) to push the second pawl teeth (2221) on the one-way rotating bolt (22) to engage with the first pawl teeth (212) on the base (211).

The fixing bolt (25) extends through the spring (24) and has an outer thread (251) corresponding to and screwed into the inner thread (2131) in the stud (213) and a head engaging the spring (24) to hold the spring (24) in place on the one-way rotating bolt (22).

The holding member (30) is tubular, is mounted in the main body (10) and has a mounting end, an inserting end, an outer surface, a cutout (31) and may have an protruding section (32), at least one positioning rib (33), a closed wall (34) and an inserting hole (35). The cutout (31) is defined in the mounting end of the holding member (30), corresponds to and is aligned with the notch (111) in the housing (11) to allow the dental floss to extend through the holding member (30) and the main body (10). The protruding section (32) is formed around the outer surface of the holding member (30) and abuts the inserting end of the housing (11) to position the holding member (30). The at least one fixing rib (33) is formed on the outer surface of the holding member (30), extends from the protruding section (32) and corresponds respectively to and engages the at least one positioning slot (113) in the housing (11) to keep the holding member (30) from rotating relative to the housing (11). The closed wall (34) is formed on the inserting end of the holding member (34). The inserting hole (35) is defined through the closed wall (34).

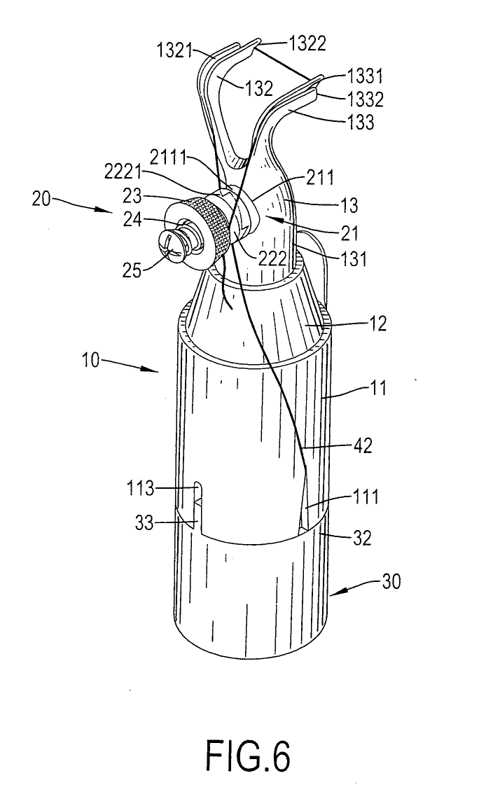

With further reference to FIG. 6, the floss package (40) is mounted in the receiving chamber in the housing (11), is held by the holding member (30) and comprises a floss spool (41) and a dental floss (42). The dental floss (42) is wound around the floss spool (41) and has distal end extending through the cutout (31) of the holding member (30) and the notch (111) in the housing (11).

When the dental floss holder is in use, the distal end of the dental floss (42) is pulled outward and wrapped through the annular groove (2111) in the base (211). Then the distal end of the dental floss (42) extends sequentially through the positioning groove (1321) and the positioning recess (1322) in the first supporting bar (132) and the positioning recess (1332) and the positioning groove (1331) in the second supporting bar (133). Finally, the distal end of the dental floss (42) is wrapped around the one-way rotating bolt (22) between the enlarged head (222) on the one-way rotating bolt (22) and the nut (23). The nut (23) is screwed fully to abut against the enlarged head (222) on the one-way rotating bolt (22) and tightly clamps the distal end of the dental floss (42).

When the distal end of the dental floss (42) is clamped and stretched, the nut (23) is farther rotated to rotate the one-way rotating bolt (22) and pull the distal end of the dental floss (42). So a tension is provided on the distal end of the dental floss (42) to stretch it and the user can put the distal end of the dental floss (42) easily between the user's teeth. Because the second pawl teeth (2221) on the one-way rotating bolt (22) engage the first pawl teeth (212) on the base (211), the one-way rotating bolt (22) is unable to rotate reversely and this prevents the distal end of the dental floss (42) from loosing. After the user's teeth are cleaned, the nut (23) is unscrewed to release the distal end of the dental floss (42) and the distal end of the dental floss (42) can be cut for next flossing.

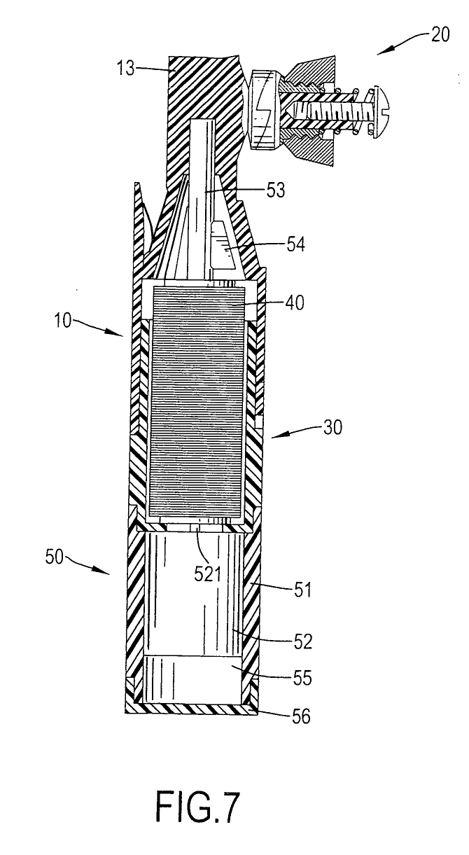

With further reference to FIG. 7, the pulsating assembly (50) is mounted on the holding member (30) and comprises a casing (51), a motor (52), a pulsating shaft (53), an eccentric block (54), a battery (55) and a cap (56). The casing (51) is cylindrical, is hollow and abuts with the outer surface of the holding member (30). The motor (52) is mounted in the casing (51) and has a motor shaft (521). The pulsating shaft (53) extends through the receiving chamber in the housing (11) and the tapered chamber (122) in the tapered section (12), is inserted into the mounting hole (1311) in the connector (131) and is connected securely to the motor shaft (521). The eccentric block (54) is mounted on the pulsating shaft (53) and is disposed in the tapered chamber (122) in the tapered section (12). When the motor (52) drives the motor shaft (521) and pulsating shaft (53) to rotate, the pulsating shaft (53) pulsates because of the eccentric block (54) and the dental floss (42) on the supporting member (13) is vibrated to rapidly enter a slit between teeth and quickly clean tartars in the silt. The battery (55) is connected selectively to the motor (52) to provide power. The cap (56) is mounted on the casing (51) to hold the battery (55) and can serve as a switch when the cap (56) is rotated to connect the battery (55) to or disconnect the battery (55) from the motor (52).

The dental floss holder as described can stretch the dental floss (42) easily by rotating the nut (23) of the stretching assembly (20) in one direction to clamp the dental floss (40) to the one-way rotating bolt (22). The dental floss (42) can be released by rotating the nut (23) in a reverse direction. Therefore, the user's teeth can be flossed conveniently without winding the dental floss (42) on the user's fingers. In addition, the length of the dental floss holder is lowered because an additional control member is not needed to control and rotate a retractable member. This also provides a capability of mounting the pulsating assembly (50) onto the holder to form a dental floss holder that can provide massage effect.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A dental floss holder comprising
a main body; and
a stretching assembly being mounted securely on the main body and comprising
a mounting member comprising
a base being circular and having
an annular surface;
an outer surface; and
an annular groove being defined in the annular surface;
multiple first pawl teeth being formed on the outer surface of the base; and
a stud being cylindrical, being formed on the center of the outer surface of the base and having a distal end;
a one-way rotating bolt being mounted rotatably on the stud of the base and having
a threaded section having;
a teeth end;
a spring end;
an outer surface; and
an outer thread being formed on the outer surface of the threaded section;
an enlarged head being formed on the teeth end of the threaded section and having
a bottom surface facing the base; and
multiple second pawl teeth being formed on the bottom surface of the enlarged head and corresponding to and engaging the first pawl teeth on the base; and
a through hole being defined through the one-way rotating bolt and accommodating the stud on the base;
a nut being screwed on the one-way rotating bolt and having an inner thread corresponding to and engaging the outer thread on the one-way rotating bolt;
a spring being mounted around the distal end of the stud and abutting the spring end of the threaded section of the one-way rotating bolt; and
a fixing bolt extending through the spring and being mounted on the stud to hold the spring.

2. The dental floss holder as claimed in claim 1, wherein
the main body comprises
a housing having
an inserting end;
a mounting end; and
a receiving chamber defined in the housing; and
a notch being defined in the inserting end of the housing;
a tapered section being mounted on the mounting end of the housing and having an outer surface; and
a supporting member being mounted on the tapered section and comprising
a connector being connected to the tapered section;
a first supporting bar being substantially inverted L-shaped and being mounted on the distal end of the connector; and
a second supporting bar being substantially inverted L-shaped and being mounted on the distal end of the connector; and
the dental floss holder further comprises a holding member mounted in the main body and having
a mounting end;
an inserting end;
an outer surface;
a cutout being defined in the mounting end of the holding member, being corresponding to and aligned with the notch in the housing; and
a closed wall being formed on the inserting end of the holding member.

3. The dental floss holder as claimed in claim 2, wherein
the first supporting bar has
an upper surface;
a distal end;
a positioning groove being defined in the upper surface of the first supporting bar; and
a positioning recess being defined in the distal end of the first supporting bar; and
the second supporting bar has
an upper surface;
a distal end;
a positioning groove being defined in the upper surface of the second supporting bar; and
a positioning recess being defined in the distal end of the second supporting bar.

4. The dental floss holder as claimed in claim 3, wherein
the housing further has a separator formed on and protruding upward from the mounting end of the housing; and
the tapered section further has a cutter mounted on the outer surface of the tapered section and facing the separator on the housing.

5. The dental floss holder as claimed in claim 4 further having a floss package mounted in the receiving chamber in the housing, held by the holding member and comprising
a floss spool; and
a dental floss being wound around the floss spool.

6. The dental floss holder as claimed in claim 5, wherein
the holding member further has an inserting hole defined through the closed wall on the holding member;
the tapered section of the main body further has a tapered chamber defined through the tapered section and communicating with the receiving chamber in the housing;
the connector of the supporting member further has a mounting hole defined in the connector and communicating with the tapered chamber in the tapered section; and
the dental floss holder further comprises a pulsating assembly mounted on the holding member and comprising
a casing being hollow and abutting with the outer surface of the holding member;
a motor being mounted in the casing and having a motor shaft;
a pulsating shaft extending through the receiving chamber in the housing and the tapered chamber in the tapered section, being inserted into the mounting hole in the connector and being connected securely to the motor shaft;
an eccentric block being mounted on the pulsating shaft and being disposed in the tapered chamber in the tapered section;
a battery being connected to the motor; and
a cap being mounted to the casing, holding the battery and serving as a switch.

7. The dental floss holder as claimed in claim 6, wherein
the housing is tubular and further has at least one positioning slot defined on the mounting end of the housing; and
the holding member is tubular and further has
a protruding section being formed on the outer surface of the holding member; and
at least one positioning rib being formed on the outer surface of the holding member, extending from the protruding section and corresponding respectively to and engaging the at least one positioning slot in the housing.

8. The dental floss holder as claimed in claim 2, wherein
the housing further has a separator formed on and protruding upward from the mounting end of the housing; and
the tapered section further has a cutter mounted on the outer surface of the tapered section and facing the separator on the housing.

9. The dental floss holder as claimed in claim 8 further having a floss package mounted in the receiving chamber in the housing, held by the holding member and comprising
a floss spool; and
a dental floss being wound around the floss spool.

10. The dental floss holder as claimed in claim 9, wherein
the holding member further has an inserting hole defined through the closed wall on the holding member;
the tapered section of the main body further has a tapered chamber defined through the tapered section and communicating with the receiving chamber in the housing;
the connector of the supporting member further has a mounting hole defined in the connector and communicating with the tapered chamber in the tapered section; and
the dental floss holder further comprises a pulsating assembly mounted on the holding member and comprising
a casing being hollow and abutting with the outer surface of the holding member;
a motor being mounted in the casing and having a motor shaft;
a pulsating shaft extending through the receiving chamber in the housing and the tapered chamber in the tapered section, being inserted into the mounting hole in the connector and being connected securely to the motor shaft;
an eccentric block being mounted on the pulsating shaft and being disposed in the tapered chamber in the tapered section;
a battery being connected to the motor; and
a cap being mounted to the casing, holding the battery and serving as a switch.

11. The dental floss holder as claimed in claim 10, wherein
the housing is tubular and further has at least one positioning slot defined on the mounting end of the housing; and
the holding member is tubular and further has
a protruding section being formed on the outer surface of the holding member; and
at least one positioning rib being formed on the outer surface of the holding member, extending from the protruding section and corresponding respectively to and engaging the at least one positioning slot in the housing.

12. The dental floss holder as claimed in claim 2 further having a floss package mounted in the receiving chamber in the housing, held by the holding member and comprising
a floss spool; and
a dental floss being wound around the floss spool.

13. The dental floss holder as claimed in claim 12, wherein
the holding member further has an inserting hole defined through the closed wall on the holding member;
the tapered section of the main body further has a tapered chamber defined through the tapered section and communicating with the receiving chamber in the housing;
the connector of the supporting member further has a mounting hole defined in the connector and communicating with the tapered chamber in the tapered section; and
the dental floss holder further comprises a pulsating assembly mounted on the holding member and comprising
a casing being hollow and abutting with the outer surface of the holding member;
a motor being mounted in the casing and having a motor shaft;
a pulsating shaft extending through the receiving chamber in the housing and the tapered chamber in the tapered section, being inserted into the mounting hole in the connector and being connected securely to the motor shaft;
an eccentric block being mounted on the pulsating shaft and being disposed in the tapered chamber in the tapered section;
a battery being connected to the motor; and
a cap being mounted to the casing, holding the battery and serving as a switch.

14. The dental floss holder as claimed in claim 13, wherein
the housing is tubular and further has at least one positioning slot defined on the mounting end of the housing; and
the holding member is tubular and further has
a protruding section being formed on the outer surface of the holding member; and
at least one positioning rib being formed on the outer surface of the holding member, extending from the protruding section and corresponding respectively to and engaging the at least one positioning slot in the housing.

15. The dental floss holder as claimed in claim 2, wherein
the holding member further has an inserting hole defined through the closed wall on the holding member;
the tapered section of the main body further has a tapered chamber defined through the tapered section and communicating with the receiving chamber in the housing;
the connector of the supporting member further has a mounting hole defined in the connector and communicating with the tapered chamber in the tapered section; and
the dental floss holder further comprises a pulsating assembly mounted on the holding member and comprising
a casing being hollow and abutting with the outer surface of the holding member;
a motor being mounted in the casing and having a motor shaft;
a pulsating shaft extending through the receiving chamber in the housing and the tapered chamber in the tapered section, being inserted into the mounting hole in the connector and being connected securely to the motor shaft;
an eccentric block being mounted on the pulsating shaft and being disposed in the tapered chamber in the tapered section;
a battery being connected to the motor; and
a cap being mounted to the casing, holding the battery and serving as a switch.

16. The dental floss holder as claimed in claim 15, wherein
the housing is tubular and further has at least one positioning slot defined on the mounting end of the housing; and
the holding member is tubular and further has
a protruding section being formed on the outer surface of the holding member; and
at least one positioning rib being formed on the outer surface of the holding member, extending from the protruding section and corresponding respectively to and engaging the at least one positioning slot in the housing.

17. The dental floss holder as claimed in claim 2, wherein
the housing is tubular and further has at least one positioning slot defined on the mounting end of the housing; and
the holding member is tubular and further has
a protruding section being formed on the outer surface of the holding member; and
at least one positioning rib being formed on the outer surface of the holding member, extending from the protruding section and corresponding respectively to and engaging the at least one positioning slot in the housing.
